(19) United States
(12) Patent Application Publication
(10) Pub. No.: US 2005/0260399 A1
(43) Pub. Date: Nov. 24, 2005

(54) Synthetic material having selective expansion characteristics

(75) Inventor: Terry Finerman, Rochester Hills, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/115,668

(22) Filed: Apr. 27, 2005

Related U.S. Application Data
(60) Provisional application No. 60/572,401, filed on May 19, 2004.

(51) Int. Cl. B29C 43/18; B32B 3/26; B61L 11/06

(52) U.S. Cl. 428/304.4; 264/259; 428/318.4

(57) ABSTRACT

A synthetic material and articles incorporating the same are disclosed. The synthetic material includes a mass of expandable material and layer or film disposed upon a surface of the expandable material. Preferably, upon expansion of the expandable material, the layer or film contracts for assisting in guiding the expansion of the expandable material.

### CLAIM OF PRIORITY

To the extent applicable, the present invention claims the benefit of the priority of U.S. Provisional Application Ser. No. 60/572,401, filed May 19, 2004, the contents of which are incorporated by reference herein.

### FIELD OF THE INVENTION

The present invention relates to a synthetic material having selective expansion characteristics, and articles incorporating the same. More particularly, the present invention relates to a synthetic material that includes an expandable material having a layer or film contacting a surface of the material for providing greater expansion at particular regions of the expandable material.

### BACKGROUND OF THE INVENTION

It is generally known to apply an expandable material to a structure of an article of manufacture for imparting strength, acoustic damping, baffling, sealing, reinforcement or the like to the structure. Such expandable materials are frequently used in articles such as buildings, containers, transportation vehicles (e.g., automotive vehicles) or the like. Typically, such expandable materials exhibit relatively uniform volumetric expansion in outward directions. However, for certain applications it can be desirable for an expandable material to exhibit greater volumetric expansion in one or more particular directions or locations as opposed to other directions or locations. As such, there is a need for an expandable or synthetic material having selective expansion characteristics.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of an exemplary synthetic material according to one aspect of the present invention;

FIG. 2 is a sectional view of an exemplary structure having the exemplary synthetic material of FIG. 1 applied thereto;

FIG. 3 is a sectional view of the structure of FIG. 2 after expansion of an expandable material of the exemplary synthetic material of FIGS. 1 and 2; and

FIGS. 4A-4D are side views of alternative exemplary synthetic materials in accordance with the present invention.

FIG. 5 illustrate the formation of an exemplary synthetic material according to one aspect of the present invention.

FIGS. 6A-6B illustrate expansion of the exemplary synthetic material of FIG. 5.

### DETAILED DESCRIPTION OF THE INVENTION

The present invention is predicated upon the provision of a synthetic material having selective expansion characteristics. Typically, the synthetic material includes an expandable material having a layer or film disposed upon one or more surfaces of the expandable material for causing the expandable material to exhibit a greater expansion (e.g., volumetric or other expansion) in one or more predetermined locations or directions. The synthetic material can be used to provide various functional attributes to a structure of an article of manufacture such as structural reinforcement, adhesion, baffling, sealing, acoustical damping properties or a combination thereof within a cavity or upon a surface of one or more structures (e.g., a body panel, a pillar structure or a frame member) of an article of manufacture (e.g., a transportation or automotive vehicle). Generally, the synthetic material may be applied directly to a structure of an article of manufacture or it may be applied to a first member (e.g., a carrier member) followed by application of the member and the material to a structural member.

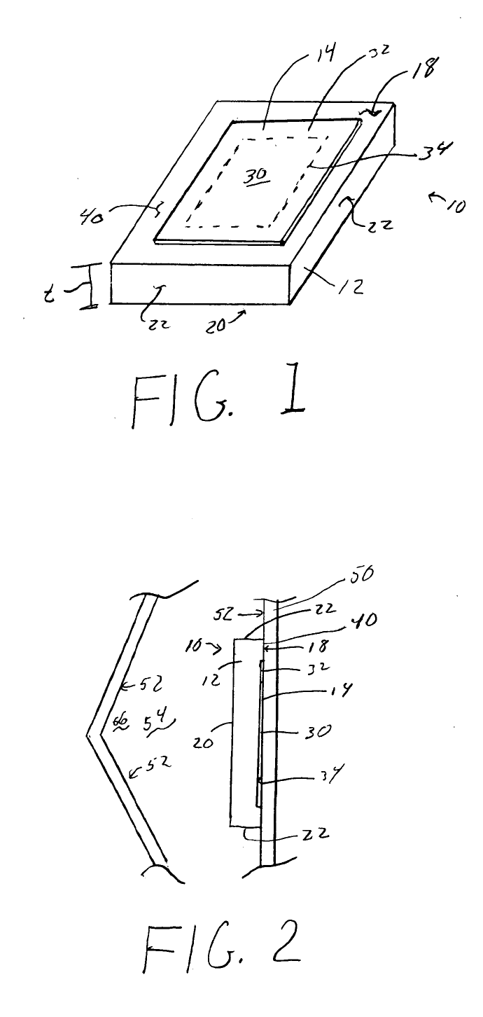

Referring to FIG. 1, there is illustrated an exemplary synthetic material 10 formed in accordance with an aspect of the present invention. The synthetic material 10 includes a mass 12 of expandable material and a layer (e.g., a film 14) disposed thereon.

The mass of expandable material of the present invention typically includes a first surface opposite a second surface and a width therebetween. Generally, the expandable material may be provided in a variety of shapes and configurations. Some preferred shapes include a disk, a block, a wedge, a tape, combinations thereof or the like. In FIG. 1, the mass 12 is generally in the shape of a block and includes a first rectangular surface 18 substantially opposite and parallel to a second rectangular surface 20. As shown, the first surface 18 is separated from the second surface 20 by a substantially uniform thickness (t), however, it is contemplated that the thickness (t) may be variable if desired. Also, as shown, a plurality of side surfaces 22 extend about the periphery of the mass 12.

The layer disposed upon the expandable material, like the mass of expandable material, may be in a variety of shapes and configurations. Thus, as used herein, the term “layer” is intended to mean any mass that has a surface suitable for contacting a surface of the expandable material.

The layer in FIG. 1, as suggested, is illustrated as a film 14. As used herein, the term “film” is intended to mean a sheet having a first surface and a second surface separated by a relatively small thickness (e.g., less than about 1 cm, more typically less than 2.0 mm and even more preferably less than about 0.5 mm). While the thickness is typically relatively thin, it is contemplated that the thickness may be variable or substantially uniform. For exemplary purposes, the present invention discusses films below, however, it should be understood that the discussions of these films can apply equally to most any layer.

In the particular embodiment of FIG. 1, the film 14 is generally rectangular and overlays a portion of the first surface 18 of the mass 12 of expandable material. Typically, the film 14 will include a central region 30 that is at least partially, and is preferably, substantially entirely surrounded by a peripheral region 32, which, as shown, are separated by a dashed line 34. As used herein, it should be understood that the central region can be any region internal of the edges of the film and the peripheral regions can be any region between the central regions and the edges of the film.

As shown, the film 14 overlays a substantial portion (e.g., greater than about 50% of the surface area) of the first surface 18, but leaves an exposed outer portion 40 of the surface 18 uncovered. As shown, that outer portion 40 is exposed on all sides of the mass 12 of expandable material, the film 14 or both, however, it is contemplated that such an exposed portion 40 may be on fewer sides, may be located centrally (e.g., may be exposed by an internal opening in the film 14), or may not be present at all.

The film 14 of FIG. 1 is also shown to be substantially continuous as it spans across the first surface 18 of the mass 12 of expandable material. It should be understood, however, that the film 14 may be non-continuous (e.g., intermittent, two or more separable films or the like) as it spans across the surface of the expandable material.

The film of the synthetic material may be formed of a variety of materials. For example, and without limitation, the film may be comprised of a fabric, a mesh, a tape or a plurality of spatially separated masses (e.g., fibers), which may or may not contact each other.

Preferably, the film is formed of a material that, upon exposure to a stimulus, tends to contract in directions parallel to the surface of the expandable material to which the film has been applied. For instance, in FIG. 1, the peripheral region 32 of the film 14 would typically move toward the central region 30 of the film 14. A variety of stimuli such as moisture, pressure, solvent exposure, light, combinations thereof or the like could potentially be employed for causing such contraction. Preferably, however, the film experiences such contraction upon exposure to heat (e.g., exposure to an elevated temperature greater than about 50° C., more typically greater than about 75° C. and even more typically greater than about 100° C.).

While it is contemplated that the film may be formed of a variety of different materials, polymeric materials are typically favored. For example, and without limitation, the polymeric materials can include polyamide, polybutylene, polyolefin, polycarbonate, polyester, polyphenylene, polyester, polypropylene, polyethylene, acrylate, acetate, halogenated polymers combinations thereof or the like. In favored embodiments for particular applications, the films are formed of a polyethylene such as low density polyethylene (LDPE), an acetate or copolymer of ethylene and acetate such as ethylene vinyl acetate (EVA), an acrylate or copolymer of ethylene and acrylate such as ethylene methacrylate (EMA), an acrylic acid or copolymer of ethylene and acrylic or methacrylic acid such as ethylene acrylic acid (EAA) or ethylene methacrylic acid (EMAA), combinations thereof or the like. It is also contemplated that the above polymers and other polymers may be formed as copolymers or terpolymers by the additional of other monomers such as glycidyl methyl acrylate (GMA). Other favored additional or alternative polymers, which may be added, include copolymers of ethylene or propylene respectively having polyethylene or polypropylene crystallinity. In particular embodiments, it is preferred that the film tends to at least slightly melt or soften upon exposure to heat such that it can wet and assist in sealing a structure to which the synthetic material is applied, however, such is not required.

It is also contemplated that the film could have correspondence components in common with the mass of expandable material. As used herein, correspondence components are polymeric components in the film that correspond to polymeric components present in the expandable material. A correspondence component may be a component in the film that is substantially identical to a component in the expandable material. Alternatively, a correspondence component may be a component of the film having a substantially identical monomer or oligomer configuration to its corresponding component in the expandable material, but the correspondence component may have a greater molecular weight or longer polymeric chain structure. As another alternative, a correspondence component may be a component in the film that is only insubstantially different from its corresponding component in the expandable material (e.g., exhibits substantially the same characteristics, has at least a similar polymeric structure, but has a higher molecular weight). Such correspondence components are further described in copending U.S. patent application Ser. No. 10/217,991, filed Aug. 13, 2002, titled “Synthetic Material and Method of Forming Same”, which is expressly incorporated herein by reference for all purposes.

Although not required, the film of the present invention is typically formed or processed by some type of stretching or thinning technique such as blowing. Thus, in one embodiment, the film is formed by heating and stretching the material of the film until the film has a desired thickness. In certain embodiments, depending upon the material used for the film, such stretching can cause the material of the film to become crystallized in a uniaxial, a biaxial or other orientation. In this manner, the film is imparted with, what is referred to in the art as “memory”, which can cause the film to contract or move as previously described upon exposure to elevated temperatures.

The film may have a variety of thickness which may be variable or uniform throughout the film. Typically the largest thickness of the film is less than about 1.0 mm, but may be greater, and more typically less than about 0.2 mm. Typically the smallest thickness of the film is greater than about 0.005 mm, but may be smaller, and more typically greater than about 0.01 and even more typically greater than about 0.02 mm. Upon exposure to a stimulus, the film is typically configured to contract at least 2% or less, more typically at least 5%, even more typically at least 10% and still more typically at least 20% of its length in one, two or more directions defined by at least one axis or possibly in directions defined by two or more axes.

Generally speaking, the expandable material of the present invention may be substantially non-tacky or dry to the touch or may be at least partially tacky at about room temperature (e.g., about 23° C.). Additionally, the expandable material can exhibit reinforcement characteristics (e.g., impart rigity, stiffness, strength or a combination thereof to a member), can exhibit baffling or acoustic characteristics (e.g., absorbs or restricts sound), sealing characteristics or other advantageous characteristics. It is also preferable for the expandable material to be activated (e.g., by heat, moisture, pressure or the like) to become flowable, expand or otherwise activate and wet surfaces which the expandable material contacts upon expansion. After and/or during expansion, the expandable material typically cures, hardens and adheres to the surfaces that it contacts.

It is typically preferable for the film to have minimal detrimental effects upon the adhesivity of the expandable material and it is contemplated that the film may enhance the adhesivity of the expandable material. Thus the film may be adhesive, particularly at elevated temperatures. Of course, it is contemplated that the film may also have minimal adhesive characteristics as well.

Depending on the purpose of the synthetic material, it is preferable for expandable material to exhibit certain characteristics such that some or all of these characteristics may also be exhibited by the synthetic material. For application purposes, it is often preferable that the expandable material exhibit flexibility, particularly when the expandable material is to be applied to a contoured surface of a structure. Once applied, however, it is typically preferable for the expandable material to be activatable to soften, expand (e.g., foam), cure, harden or a combination thereof. For example, and without limitation, a typical expandable material will include a polymeric material, such as an epoxy resin or ethylene-based polymer which, when compounded with appropriate ingredients (typically a blowing and curing agent), expands and cures in a reliable and predicable manner upon the application of heat or the occurrence of a particular ambient condition. From a chemical standpoint for a thermally-activated material, the expandable material may be initially processed as a flowable material before curing. Thereafter, the expandable material preferably cross-links upon curing, which makes the material substantially incapable of further flow.

In most applications, it is undesirable for the expandable material to be reactive at room temperature or otherwise at the ambient temperature in a manufacturing environment (e.g. up to about 40° C. or higher). More typically, the expandable material becomes reactive at higher processing temperatures, such as those encountered in painting or coating operations. For example, the expandable material may be activated at a temperature experienced in an e-coat or painting operation (e.g., coating or drying) in an automobile assembly plant. In such and embodiment, the expandable material may be foamed upon automobile components at elevated temperatures or at higher applied energy levels, e.g., during painting processing or preparation steps. Exemplary temperatures encountered in an automobile assembly operation may be in the range of up to at least about 148.89° C. to 204.44° C. or greater (about 300° F. to 400° F.), body and paint shop applications are commonly about 93.33° C. (about 200° F.) or higher. If needed, blowing agent activators can be incorporated into the expandable material to cause expansion at different temperatures outside the above ranges.

Generally, suitable expandable materials typically volumetrically expand from about 101% to about 2200% (e.g., about 150% to 2000%) of their original unexpanded size (i.e., a material that has expanded to 101% of its original size has a volume that is 1% greater than before the expansion) or greater. Furthermore, the expandable materials may volumetrically expand to as high as 1500 percent or more of their original volume. Typically, strength or reinforcement is obtained from materials that undergo relatively low expansion while materials intended for acoustic use (e.g., damping) typically undergo greater expansion. Thus, baffling or acoustic material can expand to at least 2000% or more of their original size.

Advantageously, the expandable material of the present invention may be formed or otherwise processed in a variety of ways. For example, preferred expandable materials can be processed by injection molding, extrusion, compression molding or with a robotically controlled extruder such as a mini-applicator. This enables the formation and creation of part designs that exceed the capability of most prior art materials.

It is contemplated that the expandable material may be formed of a variety of materials. For example, and without limitation, the expandable material may be formed primarily of plastics, thermoplastics, epoxy materials, elastomers and the like or combinations thereof.

In one embodiment, the expandable material may be elastomer-based. In such an embodiment, the expandable material may include or be primarily composed of elastomers such as natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons, combinations thereof and the like. In one embodiment, recycled tire rubber may be employed. One example of a suitable material, which may be used as in the expandable material is sold under the product designation L2663 and is commercially available from L&L Products, Romeo, Mich. According to exemplary formulations, when included, the expandable material can include at least about 1% or less and up to about 60% by weight elastomers, more typically, up to about 40% by weight elastomers, and even more preferably up to about 30% by weight elastomers. Of course, the preferred amount of elastomer may vary depending upon the desired application of the synthetic material.

In other embodiments, it is contemplated that the expandable material may be thermoplastic-based. In such an embodiment the expandable material may include or be primarily composed of thermoplastic materials such as polyamides, polyolefins, polyethylene, polyvinyl chlorides, polyproylene, ethylene copolymers, terpolymers and the like and combinations thereof. According to the preferred formulations, the expandable material includes up to about 40% by weight thermoplastics, more preferably, up to about 60% by weight thermoplastics, and even more preferably up to about 80% by weight thermoplastics. Of course, like the elastomer formulations, the amount of thermoplastic may vary depending upon the desired application of the synthetic material.

In yet another embodiment, the expandable material is epoxy-based and includes or is primarily composed of various epoxy containing materials. The expandable material may be formed from variety of formulations having epoxy material and preferably epoxy resin integrated therein. Epoxy resin is used herein to mean any of the conventional dimeric, oligomeric or polymeric epoxy materials containing at least one epoxy functional group. The epoxy materials may be epoxy containing materials having one or more oxirane rings polymerizable by a ring opening reaction.

The epoxy may be aliphatic, cycloaliphatic, aromatic or the like. The epoxy may be supplied as a solid (e.g., as pellets, chunks, pieces or the like) or a liquid. The epoxy may include an ethylene copolymer or terpolymer that may possess an alpha-olefin. As a copolymer or terpolymer, the polymer is composed of two or three different monomers, i.e., small molecules with high chemical reactivity that are capable of linking up with similar molecules. One exemplary epoxy resin may be a phenolic resin, which may be a novalac type or other type resin. Other preferred epoxy containing materials may include a bisphenol-A epichlorohydrin ether polymer, or a bisphenol-A epoxy resin which may be modified with butadiene or another polymeric additive. Examples of suitable epoxy-based materials, which may be used as in the expandable material are sold under the product designations L5001, L5224 and are commercially available from L&L Products, Romeo, Mich. According to preferred formulations, the expandable material can include at least or up to about 50% by weight epoxy resins, more preferably, at least or up to about 65% by weight epoxy resins, and even more preferably at least or up to about 80% by weight epoxy resins.

For forming the synthetic material, the film or layer may be applied to the mass of expandable material using a variety of techniques, which may be manual, semi-automated, or more fully automated. If the expandable material is tacky at about room temperature, the film typically need only be contacted with the surface of the expandable material such that the expandable material adheres to the film holding it in place. If the expandable material is substantially non-tacky, then it may be desirable for the film to be adhered to the surface of the expandable material with an adhesive. Alternatively, the expandable material may be heated to a temperature that allows the expandable material to wet and adhere to the film without actually activating the expandable material. For example, the expandable material may be extruded at an elevated temperature such that the expandable material is emitted from the extruder in a viscoelastic/tacky state and the film may be contacted with the expandable material (e.g., by coextrusion, manual contacting or the like) shortly after extrusion such that the expandable material can wet the film and adhere to the film as the expandable material cools and then becomes substantially non-tacky.

Application

Generally, the synthetic material is applied to a structure of an article of manufacture. In one preferred embodiment, the structure may be part of an automotive vehicle. For example, the structure might be a frame member, a body member, a bumper, a pillar, a panel, a support structure or the like of an automotive vehicle.

Preferably, the synthetic material is applied directly to a structure such that the material can provide reinforcement; acoustic damping, sealing or the like to the structure or adjacent structures or members. For application, the synthetic material may be configured with a fastener for attaching the material to a structure. Alternatively, the synthetic material may be configured with a magnet, a magnetic material, an adhesive or the like for attaching or adhering the synthetic material to the structure.

In a preferred embodiment, the expandable material of the synthetic material is tacky and can be adhered to a surface of a structure for applying the synthetic material to that structure. In such an embodiment, an individual or machine can contact at least a portion of the tacky surface of the expandable material with a surface of the structure to adhere the synthetic material to the structure.

Referring to FIG. 2, the synthetic material 10 of FIG. 1 has been applied to a structure 50 (e.g., a pillar) of an automotive vehicle. The structure 50 generally includes a plurality of walls 52 defining a cavity 54 within the structure 50. As can be seen, the exposed portion 40 of the surface 18 of the expandable material has been contacted and adhered to one wall 52 of the plurality of walls 52 such that the synthetic material 10 is located within the cavity 54.

In the embodiment shown, the synthetic material 10 has been applied to the wall 52 of the structure 50 such that the film 14 is located at least partially and preferably substantially entirely between the wall 52 and the mass 12 of expandable material. It has been found that such an arrangement can assist in providing control over the expansion of the expandable material. Alternatively, however, it is contemplated that the film 14 may be located elsewhere, for example, on the side surfaces 22 or on a surface that faces away from the wall 52 (e.g., the second surface) and still assist in controlling expansion.

During application of the synthetic material 10, it may be desirable to contact (e.g., manually or automatically) one or more surfaces (e.g., the second surface 20 or the side surfaces 22) of the mass 12 of expandable material. If those one or more surfaces 20, 22 are tacky, however, application of the synthetic material 10 can be difficult since the surfaces will tend to adhere to any entity (e.g., a gloved hand or robotic arm) that contacts the surfaces during application. As such, it is contemplated that those surfaces can be made substantially non-tacky by apply a powder, a film or a coating thereto. Examples of such are disclosed in copending U.S. patent application Ser. No. 10/217,991, filed Aug. 13, 2002 and Ser. No. Ser. No. 10/635,064, filed Aug. 6, 2003 both titled “Synthetic Material and Method of Forming Same”, both of which are expressly incorporated herein by reference for all purposes.

While the synthetic material of the present invention is typically applied directly to a structure of an article of manufacture (e.g., an automotive vehicle), it is contemplated that the synthetic material may be applied to a first member (e.g., a carrier member) for forming a reinforcement member, a baffle or other member and then the reinforcement member, baffle or other member may be applied to the article of manufacture. In the embodiment, the synthetic material may be adhered to a surface of a carrier member (e.g., a skeleton member) and then the carrier with the synthetic material thereon may be placed adjacent or within a cavity of the structure. In various embodiments, the carrier member could be formed of injection molded nylon, injection molded polymer, or molded metal (such as aluminum, magnesium, steel and titanium, an alloy derived from the metals, and even a metallic foam).

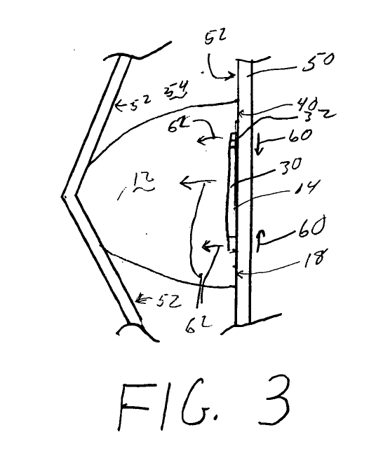

Once applied, the synthetic material and particularly the expandable material may be activated by heat (e.g.,, from paint ovens or the like described herein) or otherwise to expand and adhere to the various walls of the structure. As shown in FIG. 3, the mass 12 of expandable material has expanded across the cavity 54 to contact and adhere to the opposing walls 52 of the structure 50. In such an embodiment, it may desirable for the synthetic material 10 to span the entire cavity 54 preventing passage of materials therethrough, although such is not required.

During expansion of the mass 12 of expandable material, the film 14 typically contracts in directions (shown with arrows 60) parallel to the surface 18 to which the film 14 has been applied. As can be seen, the. peripheral region 32 of the film 14 moves toward the central region 30 of the film 14. In turn, the expansion distance (the direction of which is shown with arrows 62) or expansion volume of the mass 12 of expandable material away from the central region 30 and/or the film 14, in general, is accelerated or increased relative to an expandable material not having the film. As such, the mass 12 of expandable material, upon expansion, can span or extend a further distance away from the film 14, the wall 52 away from which it expands or both. Such expansion can be particularly advantageous in situations, like in FIGS. 2 and 3, where the mass 12 of expandable material needs to span a greater distance due to one or more contours (e.g., a recess 66) defined by the structure 50.

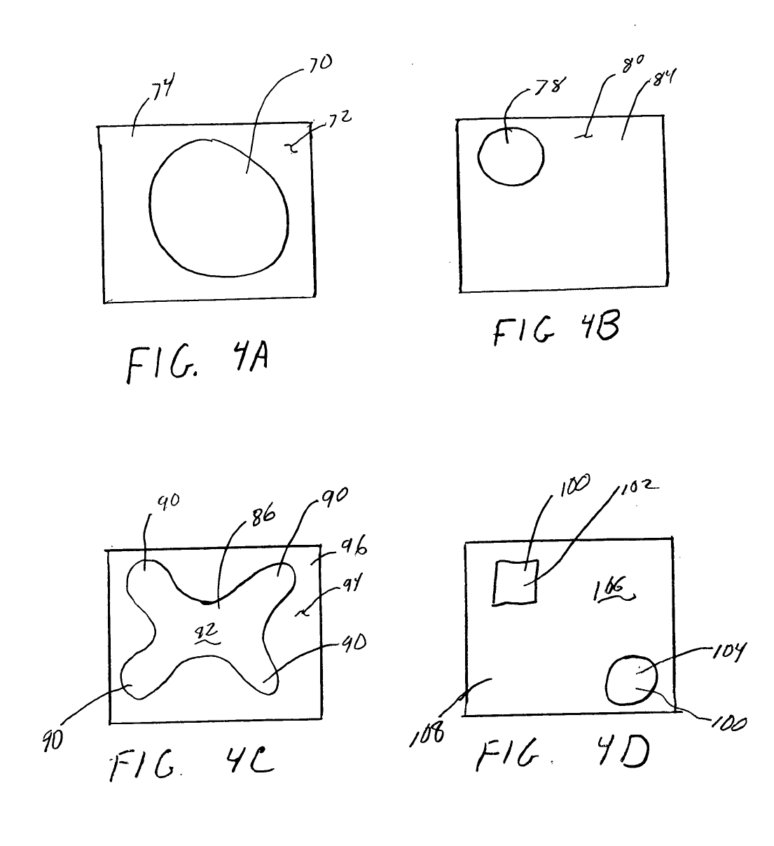

As suggested previously, the film or layer may be in a variety of different configurations upon the mass of expandable material. As such, it is contemplated that a synthetic material according to the present invention may be tailored to fill a particular cavity, to seal a particular opening (e.g., cavity or recess) or substrate or to perform other similar functions. For exemplary purposes, FIGS. 4A-4B show a few of many potential alternative embodiments of the synthetic material of the present invention. FIG. 4A illustrates a film 70 that is generally round (e.g., circular, elliptical or oblong) as it spans a substantial portion of a surface 72 of a mass 14 of expandable material. FIG. 4B illustrates a film 28 that is generally circular as it spans a relatively small portion of a surface 80 of a mass 84 of expandable material. FIG. 4C illustrates a film 86 that has four extensions 90 extending from a middle portion 92 of the film 86 for spanning at least a portion of a surface 94 of a mass 96 of expandable material. FIG. 4D illustrates a film 100 that has a rectangular portion 102 and a circular portion 104 spatially separated from each other and spanning relatively small portions of a surface 106 of a mass 108 of expandable material.

In alternative embodiments, it is contemplated that a layer of the expandable material, which may include a portion (e.g. a surface, integral film or peripheral area) or the entirety of the mass of expandable material may be crystalline and oriented as was described with respect to the film. In such an embodiment, such crystallinity and/or orientation of the mass of expandable material may assist in directing the expansion of the expandable material as was also described with respect to the film. When the mass of expandable material has such crystallinity and/or orientation, it is contemplated that the synthetic material of the present invention may be formed with or without a film.

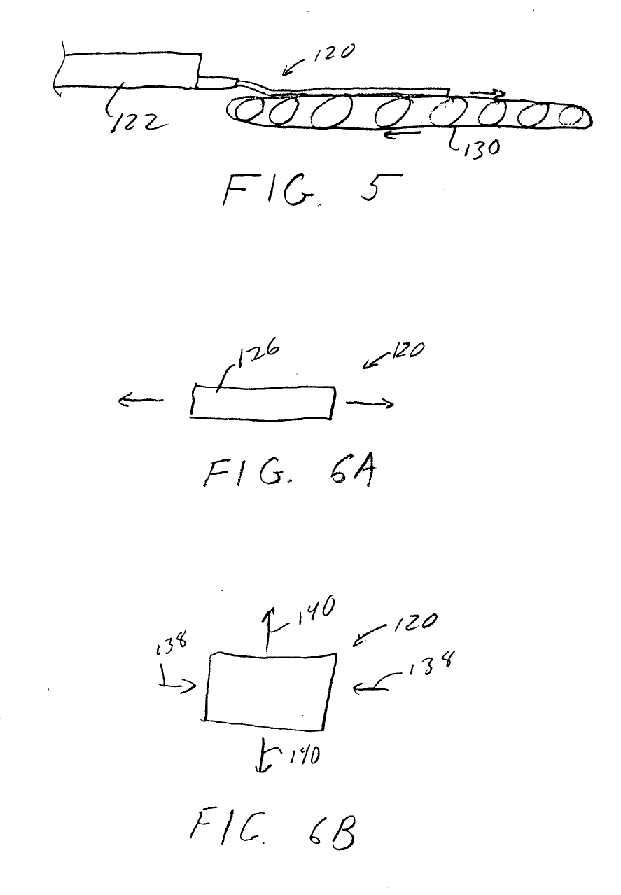

Referring to FIGS. 5-6A, there is illustrated the formation and expansion of a synthetic material 120 according to one alternative embodiment of the present invention. As can be seen in FIG. 5, the synthetic material 120 is formed in an extruder 122 and then extruded as a strip. Thereafter, the synthetic material 120 can be cut to form one or more masses 126 as shown in FIGS. 6A and 6B.

Preferably, the synthetic material 120 is itself a layer of expandable material, which may be substantially homogeneous or may include one or more integrally formed layers of materials of different composition. As such, either the layer of substantially homogenous expandable material or one or more layers of a multi-layer synthetic material includes one or more crystalline materials intermixed therein such as those discussed above in relation to the film. In the embodiment shown, the synthetic material 120 is a substantially homogeneous layer of expandable material.

During or after formation, the synthetic material 120 or a portion or layer thereof can be stretched to orient the crystalline materials of the synthetic material. In FIG. 5, a belt 130 is operated at a speed that tends to stretch and/or pull the synthetic material 120 as it exits the extruder 122. As such, the mass 126 shown in FIG. 6A is stretched in the directions 134, indicated by arrows in that drawing, thereby orienting the crystalline materials in those directions 134. Upon heating and/or expansion of the synthetic or expandable material 120, the crystalline materials will at least attempt to regain their pre-oriented or pre-stretched shape by contracting in directions 138 opposite the directions 134 of stretching. In turn, the synthetic material 120 will tend to have greater expansion in directions 140 perpendicular to the directions 134 of stretching. Of course, it should be noted that the synthetic material 120 may still expand in directions opposite the directions 138 of contraction due to the overall expansion of the material 120 even though a contraction of the crystalline or oriented material may be happening in close proximity in time.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A synthetic material comprising:
a mass of expandable material having at least one surface; and
a layer of oriented material contacting the mass of expandable material, wherein, upon expansion of the expandable material, the layer of oriented material contracts in at least one direction and directs expansion of the expandable material in one or more directions substantially perpendicular to the at least one direction.

2. A synthetic material as in claim 1 wherein the layer of oriented material is a stretched portion of the mass of expandable material.

3. A synthetic material as in claim 2 wherein the entirety of the mass of expandable material is stretched to form the layer of oriented material.

4. A synthetic material as in claim 1 wherein the layer of oriented material is a separate film that is disposed upon a surface of the mass of expandable material.

5. A synthetic material as in claim 1 wherein the layer of oriented material contracts due to crystalline orientation of the region.

6. A synthetic material as in claim 1 wherein the mass of expandable material expands upon exposure to a temperature typically experienced in an automotive e-coat, paint or primer oven.

7. A synthetic material as in claim 6 wherein the mass of expandable material is a thermosettable material.

8. A synthetic material as in claim 7 wherein the mass of expandable material includes an epoxy resin, an acrylate or an acetate.

9. A synthetic material as in claim 1 wherein the mass of expandable material includes at least one elastomer.

10. A synthetic material as in claim 1 wherein the mass of expandable material includes a blowing agent or a curing agent that becomes reactive at a temperature typically experienced in an automotive e-coat or paint oven.

11. A synthetic material comprising:
a mass of expandable material having at least one surface; and
a layer disposed upon the at least one surface, the layer being a film wherein;
i) the film includes a peripheral region and a central region;
ii) upon expansion of the expandable material, the film contracts in directions parallel to the at least one surface such that the peripheral region moves toward the central region, which causes mass of expandable material to expand further away from the layer.

12. A synthetic material as in claim 11 wherein the surface of the mass of expandable material is tacky for assisting in adhering the film to the surface.

13. A synthetic material as in claim 11 wherein the film is of a size that leaves an outer region of the surface of the mass of expandable material exposed

14. A synthetic material as in claim 11 wherein the film is substantially continuous upon the surface of the mass of expandable material.

15. A synthetic material as in claim 11 wherein the film is formed of a crystalline polymeric material.

16. A synthetic material as in claim 11 wherein the film is crystallized to have a uniaxial or biaxial orientation.

17. A synthetic material as in claim 11 wherein the film has a largest thickness that is less than about 0.2 mm.

18. A synthetic material as in claim 11 wherein the film has a smallest thickness that is greater than about 0.01 mm.

19. A synthetic material as in claim 1 wherein:
i. the film is formed of an oriented stretched crystalline material;
ii. the mass of expandable material expands upon exposure to a temperature typically experienced in an automotive e-coat, paint or primer oven;
iii. the mass of expandable material is a thermosettable material;
iv. the mass of expandable material includes an epoxy resin, an acrylate or an acetate; and
v. the mass of expandable material includes at least one elastomer.

20. A method of providing sealing, reinforcement or baffling to a structure of an article of manufacture, the method comprising:
providing a synthetic material wherein the synthetic material includes:
i) a mass of expandable material having at least one surface; and
ii) a layer disposed upon the at least one surface, the layer being a film having a peripheral region and a central region substantially entirely surrounded by the peripheral region;
placing a synthetic material within a cavity defined by at least one wall of the structure such that the film is located substantially entirely between the at least one wall and the mass of expandable material;
heating the synthetic material causing the expandable material to expand and simultaneously causing the film to contract in directions parallel to the at least one surface wherein:
i) the film contracts such that the peripheral region moves toward the central region causing the expandable material to expand further away from the film.
